(19) United States
(12) Patent Application Publication
(10) Pub. No.: US 2022/0049325 A1
(43) Pub. Date: Feb. 17, 2022

(54) METHOD FOR PROTECTION AGAINST FRETTING FATIGUE BY COMPOUND MODIFICATION VIA LASER SHOCK PEENING AND COATING LUBRICATION

(71) Applicants: Dalian University of Technology, Dalian (CN); AVIC Manufacturing Technology Institute, Beijing (CN)

(72) Inventors: Xuesong FU, Dalian (CN); Zhiqiang LI, Beijing (CN); Ziwen CAO, Beijing (CN); Maozhong LUO, Dalian (CN); Wenlong ZHOU, Dalian (CN); Guoqing CHEN, Dalian (CN); Yufei ZU, Dalian (CN)

(73) Assignees: Dalian University of Technology, Dalian (CN); AVIC Manufacturing Technology Institute, Beijing (CN)

(21) Appl. No.: 17/386,693

(22) Filed: Jul. 28, 2021

(30) Foreign Application Priority Data
Aug. 13, 2020 (CN) 202010814090.3

(51) Int. Cl. C21D 10/00; B23K 26/356

(52) U.S. Cl. CPC C21D 10/005; B23K 26/356

(57) ABSTRACT

The present disclosure provides a method for protection against fretting fatigue by compound modification via laser shock peening and coating lubrication, where a group of micro-pits distributed into a regular array is firstly formed in a surface of a metal material by using laser shock peening, with a single micro-pit having a diameter of 1 to 10 mm and a depth of 1 to 20 μm; and the micro-pits are then coated with a lubricant by coating preparation. Based on the micro-pit styling feature and surface residual compressive stress introducing feature of the laser shock peening, with compound modification by surface texturing via the laser shock peening and coating lubrication, the surface of the material can be reinforced by residual compressive stress, coating lubrication and surface micro-pit texturing with a synergistic effect, thus allowing for improved fretting fatigue behavior of the material.

### CROSS REFERENCE TO RELATED APPLICATION

This patent application claims the benefit and priority of Chinese Patent Application No. 202010814090.3 filed on Aug. 13, 2020, the disclosure of which is incorporated by reference herein in its entirety as part of the present application.

### TECHNICAL FIELD

The present disclosure belongs to the technical field of surface protection, relates to a method for surface modification of a structural metal part with the purpose of improving the fretting fatigue behavior of a material, and in particular, to a method for protection against fretting fatigue by compound modification via laser shock peening and coating lubrication.

### BACKGROUND ART

In machinery manufacturing, components and parts commonly used in immovable fitting such as riveted connection, bolted connection and mortise and tenon connection are prone to fretting fatigue in vibration environment. A tiny displacement (on the micron scale) of a contact surface of a part may cause friction and wear of the contact surface, resulting in greatly reduced fatigue strength or life. For example, Ti-1023 titanium alloy may have a reduction of 80% in fatigue strength under fretting load. The protection strategy against the fretting fatigue is mainly directed to the prolonging of the service life by surface engineering techniques. Common surface protection techniques include coating, plating, ion implantation, mechanical shot peening, laser shock peening, low plastic polishing, rolling, etc. For most of the existing protection measures against fretting, surface modification techniques are usually used alone. Examples are a Chinese patent (201410730008.3, 2014) entitled “Preparation Method for Tin Phase Reinforced Ag Solid Lubricant Film by Ion Assisted Deposition”, and “Experimental results in fretting fatigue with shot and laser peened Al 7075-T651 specimens” published by Spanish researchers in 2012 (International Journal of Fatigue 40 (2012) 143-153). Each of such reported protection techniques or methods against fretting fatigue is based on a single protection technique. Compound modification is based on a combination of two or three protection techniques to achieve a synergistic effect of multiple reinforcing factors, and is not only a hot spot but also a difficult problem in global academic circles. This is because a compound modification process usually involves a combination of two technical measures, which may easily arouse performance interference or conflict.

### SUMMARY

To solve the technical problem of performance interference or conflict easily occurring during compound modification for protection against fretting fatigue, a method for protection against fretting fatigue by compound modification via laser shock peening and coating lubrication is provided. According to the present disclosure, the laser shock peening and the coating lubrication are combined without interference and conflict, and therefore, the fretting fatigue resistance of a component can be further improved.

The follows technical means are adopted in the present disclosure.

A method for protection against fretting fatigue by compound modification via laser shock peening and coating lubrication is provided, where a group of micro-pits distributed into a regular array is firstly formed in a surface of a metal material by using laser shock peening, with a single micro-pit having a diameter of 1 to 10 mm and a depth of 1 to 20 μm; and the micro-pits are then coated with a lubricant by coating preparation.

Further, the laser shock peening may be carried out by partial overlapping of individual spots along a laser shock path, where the spot is circular or square and an overlapping rate of the spots is 10% to 50%.

Further, the method may specifically include following steps:

S1: surface pretreatment of a specimen to be treated by laser shock peening;

covering a surface of the specimen to be treated by laser shock peening with an aluminum foil and spraying deionized water over a position for laser shock peening to form a 1 mm thick deionized water film;

S2: formation of a group of micro-pits in the surface of the specimen to be treated by laser shock peening by using the laser shock peening;

S3: surface cleaning of the laser shock peened specimen;

removing the aluminum foil from the surface of the specimen after the completion of the laser shock peening and cleaning the surface of the laser shock peened specimen with an organic solvent;

S4: surface coating of the specimen with the lubricant;

coating the surface of micro-pits (micro-pit texture) with the lubricant by coating technology, where during the coating preparation, temperatures of the specimen and the lubricant and an ambient temperature do not exceed 600° C.

Further, the laser shock peening may be carried out by using a pulsed solid-state neodymium glass laser with a laser light wavelength of 1064 nm, a pulse width of 10 to 30 ns, a pulse energy density of 1 to 30 J, and a circular or square spot having a diameter of 1 to 10 mm.

Further, the coating preparation may be carried out by plasma spraying, deposition, chemical deposition or electroplating.

Further, the lubricant may be a solid coating material.

Further, the lubricant may be a CuNiIn material, molybdenum disulfide, a soft metal or nylon.

Compared with the prior art, the present disclosure has the following advantages.

The method for protection against fretting fatigue by compound modification via laser shock peening and coating lubrication provided in the present disclosure permits the reinforcement of the surface of a material by residual compressive stress, coating lubrication and surface micro-pit texturing with a synergistic effect, thus allowing for improved fretting fatigue behavior of the material. As a result, the surface of contact is enabled to have a good lubrication state and low friction. Besides, the release of useful residual compressive stress induced by the laser shock peening is retarded and the life is prolonged during fretting fatigue propagation. The surface of contact is protected with a lubricating coating, so that the fretting wear and frictional shear stress of the surface of contact are reduced, and the life is prolonged during fretting fatigue crack initiation. An antifriction laser shock peening textured surface is created by the accessory micro-pit styling effect of the laser shock peening, and the wear time of the lubricating coating is thus prolonged.

For the above reasons, the present disclosure can be promoted in the field of surface protection and other fields.

### BRIEF DESCRIPTION OF THE DRAWINGS

To describe the technical solutions in examples of the present disclosure or in the prior art more clearly, the accompanying drawings required for describing the examples or the prior art will be described below briefly. Apparently, the accompanying drawings in the following description show some examples of the present disclosure, and other drawings can be derived from these accompanying drawings by a person of ordinary skill in the art without creative efforts.

FIG. 1 is a schematic diagram of a laser shock peening textured surface with micro-pits according to an example of the present disclosure.

FIG. 2 is a schematic diagram of a cross section after compound modification via laser shock peening and coating lubrication according to an example of the present disclosure.

In the figures, 1 denotes a specimen for laser shock peening, while 2 a spot and laser shock path representation during the laser shock peening, 3 a cross sectional view of the laser shock peened specimen in the thickness direction, and 4 a contour line of micro-pits formed in the surface of the laser shock peened specimen, and 5 a coating material.

### DETAILED DESCRIPTION OF THE EMBODIMENTS

In order to make the objectives, technical solutions and advantages of the examples of the present disclosure clearer, the technical solutions in the examples of the present disclosure will be described below clearly and completely with reference to the accompanying drawings in the examples of the present disclosure. Apparently, the described examples are some rather than all of the examples of the present disclosure. The following description of at least one exemplary example is merely illustrative, and not intended to limit the present disclosure and application or use thereof in any way. All other examples derived from the examples of the present disclosure by a person of ordinary skill in the art without creative efforts shall fall within the protection scope of the present disclosure.

### Example 1

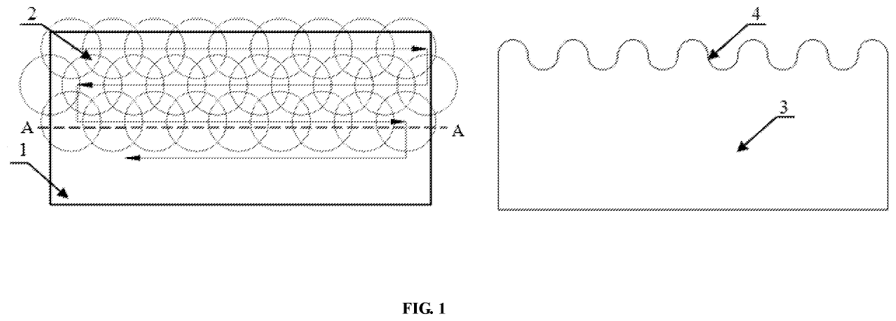

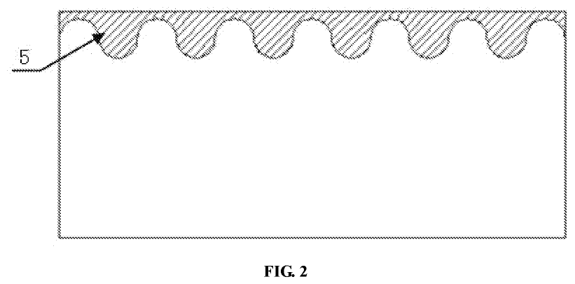

As shown in FIG. 1 and FIG. 2, the present disclosure provides a method for protection against fretting fatigue by compound modification via laser shock peening and coating lubrication. The laser shock peening and the coating lubrication were combined to provide a novel integrated surface protection technique, which specifically included the following steps.

The surface of micro-pits (micro-pit texture) distributed into a regular array was firstly formed in a surface of a metal material by using laser shock peening, with a single micro-pit having a diameter of 1 to 10 mm and a depth of 1 to 20 μm; and the micro-pits were then coated with a lubricant by coating preparation.

Further, the laser shock peening was carried out by partial overlapping of individual spots along a laser shock path, where the spot was circular or square and an overlapping rate of the spots was 10% to 50%. In the present disclosure, the coverage of the laser shock peening on the surface of the specimen could be above 100%.

Further, the coating preparation was carried out by plasma spraying, physical deposition, chemical deposition or electroplating.

Further, the lubricant was a solid coating material.

Further, the lubricant was a CuNiIn material, molybdenum disulfide, a soft metal or nylon.

FIG. 1 shows a specimen 1 for laser shock peening, a spot and laser shock path representation 2 during the laser shock peening, a cross sectional view 3 of the laser shock peened specimen in the thickness direction, a contour line 4 of micro-pits formed in the surface of the laser shock peened specimen and a coating material 5.

Further, the method for protection against fretting fatigue by compound modification via laser shock peening and coating lubrication specifically included the following steps:

S1: surface pretreatment of the specimen 1 to be treated by laser shock peening.

A surface of the specimen 1 to be treated by laser shock peening was covered with a 0.12 mm thick aluminum foil, so that the material surface was protected, and deionized water was sprayed over a position for laser shock peening to form a 1 mm thick deionized water film for inhibiting plasma over-expansion and increasing shock wave pressure.

S2: formation of a group of micro-pits (micro-pit texture) in the surface of the specimen to be treated by laser shock peening by using the laser shock peening.

The surface of the specimen 1 to be treated by laser shock peening was shocked with circular or square spots along a laser shock path as shown in FIG. 1. The surface of the specimen was reinforced by partial overlapping of individual spots, guaranteeing that the coverage of the laser shock peening on the specimen surface was above 100%. An overlapping rate of the spots was 10% to 50% and the spot had a diameter (side length) of 1 to 10 mm. A group of micro-pits (micro-pit texture) distributed into a regular array was formed in the surface along the set laser shock path, with the contour line 4 of the micro-pits formed in surface of the laser shock peened specimen being as shown in FIG. 1.

The process parameters of the laser shock peening were as follows: a pulsed solid-state neodymium glass (ND:YAG) laser with a laser light wavelength of 1064 nm, a pulse width of 10 to 30 ns, a pulse energy density of 1 to 30 J, and a circular or square spot having a diameter (side length) of 1 to 10 mm.

S3: surface cleaning of the laser shock peened specimen.

The aluminum foil was removed from the surface of the specimen after the completion of the laser shock peening and the surface of the laser shock peened specimen 1 was cleaned with an organic solvent.

S4: surface coating of the specimen with the lubricant.

The surface of micro-pits (micro-pit texture) was coated with the lubricant by coating technology, so that compound modification by micro-pit texturing via the laser shock peening and the coating lubrication was achieved. During the coating preparation, temperatures of the specimen and the lubricant and an ambient temperature did not exceed 600° C.

Based on the micro-pit styling feature and surface residual compressive stress introducing feature of the laser shock peening, with compound modification by surface texturing via the laser shock peening and coating lubrication, the surface of the material can be reinforced by residual compressive stress, coating lubrication and surface micro-pit texturing with a synergistic effect, thus allowing for improved fretting fatigue behavior of the material. The compound modification can result in enhanced fretting wear resistance of the coating, reduced surface friction, retarded residual stress relaxation, and prolonged fretting fatigue life.

Finally, it should be noted that the above example is merely intended to describe the technical solutions of the present disclosure, rather than to limit the present disclosure. Although the present disclosure is described in detail with reference to the above example, a person of ordinary skill in the art will understand that modifications can be made to the technical solutions described in the above example or equivalent replacements can be made to some or all technical features thereof. However, these modifications or replacements do not cause the essence of the corresponding technical solutions to depart from the scope of the technical solutions of the example of the present disclosure.

What is claimed is:

1. A method for protection against fretting fatigue by compound modification via laser shock peening and coating lubrication, comprising forming a group of micro-pits distributed into a regular array on a surface of a metal material by using laser shock peening, with a single micro-pit having a diameter of 1 to 10 mm and a depth of 1 to 20 μm; and coating the micro-pits with a lubricant by coating preparation.

2. The method for protection against fretting fatigue by compound modification via laser shock peening and coating lubrication according to claim 1, wherein the laser shock peening is carried out by partial overlapping of individual spots along a laser shock path, wherein the spot is circular or square and an overlapping rate of the spots is 10% to 50%.

3. The method for protection against fretting fatigue by compound modification via laser shock peening and coating lubrication according to claim 2, specifically comprising the following steps:
S1: surface pretreatment of a specimen to be treated by laser shock peening;
covering a surface of the specimen to be treated by laser shock peening with an aluminum foil and spraying deionized water over a position for laser shock peening to form a 1 mm thick deionized water film;
S2: formation of a group of micro-pits in the surface of the specimen to be treated by laser shock peening by using the laser shock peening;
S3: surface cleaning of the laser shock peened specimen;
removing the aluminum foil from the surface of the specimen after the completion of the laser shock peening and cleaning the surface of the laser shock peened specimen with an organic solvent;
S4: surface coating of the specimen with the lubricant;
coating the surface of micro-pits (micro-pit texture) with the lubricant by coating technology, wherein during the coating preparation, temperatures of the specimen and the lubricant and an ambient temperature do not exceed 600° C.

4. The method for protection against fretting fatigue by compound modification via laser shock peening and coating lubrication according to claim 3, wherein the laser shock peening is carried out by using a pulsed solid-state neodymium glass laser with a laser light wavelength of 1064 nm, a pulse width of 10 to 30 ns, a pulse energy density of 1 to 30 J, and a circular or square spot having a diameter of 1 to 10 mm.

5. The method for protection against fretting fatigue by compound modification via laser shock peening and coating lubrication according to claim 1, wherein the coating preparation is carried out by plasma spraying, physical deposition, chemical deposition or electroplating.

6. The method for protection against fretting fatigue by compound modification via laser shock peening and coating lubrication according to claim 1, wherein the lubricant is a solid coating material.

7. The method for protection against fretting fatigue by compound modification via laser shock peening and coating lubrication according to claim 6, wherein the lubricant is a CuNiIn material, molybdenum disulfide, a soft metal or nylon.
